(19) United States
(12) Patent Application Publication
(10) Pub. No.: US 2026/0342825 A1
(43) Pub. Date: Oct. 29, 2026

(54) TRUST SCORING FRAMEWORK FOR RESOURCES

(71) Applicant: Dell Products L.P., Round Rock, TX (US)

(72) Inventors: Deepak Gaikwad, Natick, MA (US); Judith A. Furlong, Natick, MA (US); Raj Suryavanshi, Leander, TX (US)

(21) Appl. No.: 19/188,900

(22) Filed: Apr. 24, 2025

(51) Int. Cl. H04L 9/40; G06F 21/57

(52) U.S. Cl. CPC H04L 63/1425; G06F 21/57

(57) ABSTRACT

The disclosed method involves accessing request data associated with a set of resources to evaluate their security postures based on adherence to specified security policies. The request data is stored in a request data store. A first machine-learning (ML) model classifies the request data into event categories. Subsequently, a second ML model generates a trust score for each resource, reflecting its security posture. The trust score generation utilizes dynamic weights influenced by anomalous events or historical trust score patterns. This approach enables the assessment and classification of security-related events and the determination of trust scores, thereby facilitating enhanced security management for the resources.

### TECHNOLOGICAL FIELD OF THE DISCLOSURE

Embodiments disclosed herein generally relate to trust scoring of resources in a trust environment. More particularly, at least some embodiments relate to systems, hardware, software, computer-readable media, and methods for dynamically determining trust scores based on anomalous events and/or historical patterns.

### BACKGROUND

A trust environment typically is a mix of heterogenous resources such as compute, network, storage, applications, workloads etc. that interact with internal and external identities to satisfy intent requests and generate desired outcomes. Trustworthiness of individual resources in the environment is critical in the overall system operation. However, these resources can be affected by dynamic internal or external events that change their overall trustworthiness.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a trust environment including a trust scoring module according to the embodiments disclosed herein.

FIGS. 2A-2C disclose aspects of performing trust scoring using dynamic weights according to the embodiments disclosed herein.

FIGS. 3A-3C disclose aspects of performing trust scoring using historical trust score patterns according to the embodiments disclosed herein.

FIG. 4 discloses aspects of a method according to the embodiments disclosed herein.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to trust scoring of resources in a trust environment. More particularly, at least some embodiments relate to systems, hardware, software, computer-readable media, and methods for dynamically determining trust scores based on anomalous events and/or historical patterns.

The disclosed method involves accessing request data associated with a set of resources to evaluate their security postures based on adherence to specified security policies. The request data is stored in a request data store. A first machine-learning (ML) model classifies the request data into event categories. Subsequently, a second ML model generates a trust score for each resource, reflecting its security posture. The trust score generation utilizes dynamic weights influenced by anomalous events or historical trust score patterns. This approach enables the assessment and classification of security-related events and the determination of trust scores, thereby facilitating enhanced security management for the resources.

In some aspects, the techniques described herein relate to a method, including: accessing request data and including the request data in a request data store, the request data being associated with a set of resources that are being evaluated to determine security postures for the set of resources based on adherence to a set of one or more security policies; causing a first machine-learning (ML) model to classify the request data received from the set of resources into event categories associated with the requested data; causing a second ML model to generate a trust score for each respective resource in the set of resources based on the request data, the trust scores reflecting the security postures for each of the resources in the set of resources, wherein the generation of the trust score for each resource in the set of resources is performed using one or more of: dynamic weights that are based anomalous events, or historical trust score patterns.

In some aspects, the techniques described herein relate to a non-transitory storage medium having stored therein instructions that are executable by one or more hardware processors to perform operations including: accessing request data and including the request data in a request data store, the request data being associated with a set of resources that are being evaluated to determine security postures for the set of resources based on adherence to a set of one or more security policies; causing a first machine-learning (ML) model to classify the request data received from the set of resources into event categories associated with the requested data; causing a second ML model to generate a trust score for each respective resource in the set of resources based on the request data, the trust scores reflecting the security postures for each of the resources in the set of resources, wherein the generation of the trust score for each resource in the set of resources is performed using one or more of: dynamic weights that are based anomalous events, or historical trust score patterns.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

At least some of the embodiments disclosed herein may implement one or more machine learning models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The embodiments disclosed herein provide for a novel framework that augments trust scoring with dynamic weights based on internal and external events affecting the trustworthiness of individual resources withing a trust environment. The framework allows for insights to be taken from event patterns and associated metadata to make customization to the dynamic weights. The framework enables mapping (as well as simulating) a resource or systems adaptability to different environmental behaviors (events, etc.) correlated to the trust scoring metric and proactively applying remediations/reconciliations. The framework dynamically adapt trust scoring based on historical resource access patterns and changes in trust score for a resource or environment to provide precise policy recommendations. The framework allows for precise calculation of a present trust score by leveraging adaptive analysis thresholding that optimizes the data sample segments for a specific environment/resource with references from prior trust score patterns. The framework provides an intelligent visualization of the drift between resource trust scores over time with a knowledgeable explanation of the reasoning behind the change and its effects.

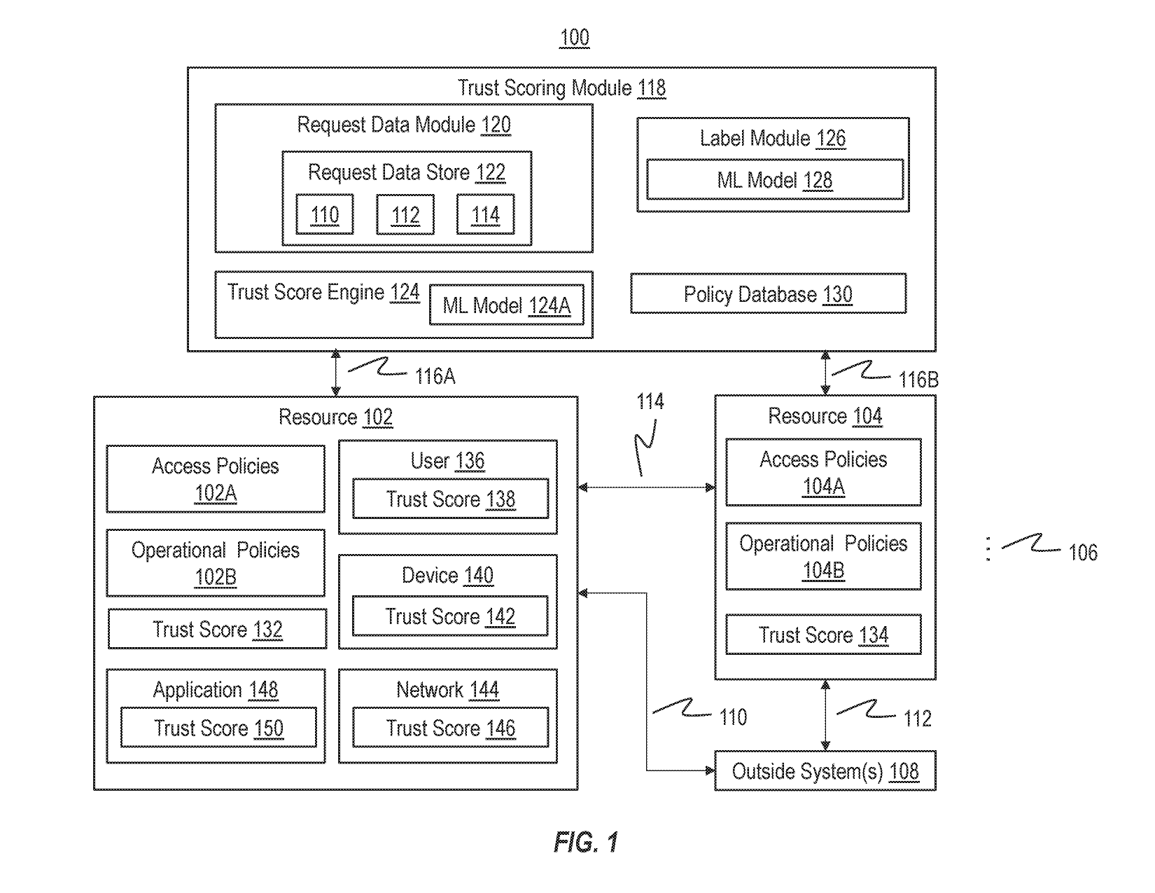

FIG. 1 illustrates an embodiment of a trust environment 100. As illustrated, the environment 100 includes various resources including a resource 102, a resource 104, and any number of additional resources 106 as illustrated by the ellipses. The resources 102, 104, and 106 include a mix of heterogeneous resources including both physical resources and logical resources. Examples of the resources 102, 104, and 106 include, but are not limited to, compute resources, network resources, storage resources, application resources, and workloads.

In operation, a request represents the transactions, such as access requests and other interactions, between the resources 102, 104, and 106 and between one or more of the resources 102, 104, and 106 and one or more of outside systems 108 that are outside of the trust environment 100 to generate a desired outcome. For example, a request 110 represents the transactions between the resource 102 and one or more of the outside systems 108, a request 112 represents the transactions between the resource 104 and the one or more outside systems 108, and a request 114 represents the transactions between the resource 102 and the resource 104. Although not illustrated, there can also be requests between the additional resources 106 and the resource 102 and/or 104 and/or one or more of the outside systems 108.

In order to maintain the overall security posture of the trust environment 100, each of the resources 102, 104, and 106 is associated with security policies including access polices and operational policies that should be enforced for every request. The access policies are runtime policies that dictate such things as how a resource is to be accessed, when the resource should be accessed, where a resource should be accessed from, and what types of entities can access the resource. Thus, the access polices enhance the security of the trust environment 100 by providing access safeguards. The operational policies specify the operational configurations a resource can have, such as if it will function as a server resource, a storage resource, a compute resource, and how the resource will interact with the physical network hardware. Thus, the operational polices enhance the security of the trust environment 100 by providing safeguards for the operation of the resource and for software and hardware of the resource. Of course, the resources 102, 104, and 106 can also be associated with other security policies that enhance the security of the trust environment 100 as circumstances warrant. As illustrated, the resource 102 includes access policies 102A and operational policies 102B and the resource 104 includes access policies 104A and operational policies 104B. Although not illustrated, the additional resources 106 also include access policies and operational policies.

As mentioned, the security policies including the access policies and operational policies should be enforced for every request. Thus, it is important to evaluate how well a resource complies with the access and operational policies. In other words, it is important to know how trustworthy a resource is given that if a resource is not properly enforcing the policies, the overall security of the trust environment 100 can be comprised. Accordingly, the trust environment 100 includes a trust scoring module 118 that is able to evaluate how well a resource complies with the security policies including the access policies and operational policies and then generate a trust score for the resource based on the compliance. The trust score provides a real time metric that measures how well a resource is complying with the security policies, thus reflecting the overall security posture of the resource. In addition, in some instances there may not be a security policy in place for a type of request or perhaps the security policy needs to be updated to reflect changes to the operations of the resource. In such cases, the trust score can provide insight into the need to add and/or update one or more of the security policies to maintain or achieve a desired security posture for the resource.

In operation, the trust scoring module 118 includes a request data module 120 that collects the requests of the resources, such as requests 110, 112, and 114, as shown at 116A for resource 102 and 116B for resource 104. Although not illustrated, the trust scoring module 118 also collects the requests for the additional resources 106. The request data module 120 then stores the requests in a request data store 122. A label module 126 then uses a machine learning (ML) model 128, which may be a classifier, to tag/label the requests stored in the request data store 122 based on request endpoints into possible operation/event categories.

The trust scoring module 118 includes a trust score engine 124 and a policy database 130. The policy database 130 includes or otherwise has access to the various security policies including the access and operational policies of the resources 102, 10, and 106. In operation, the trust score engine 124, which may implement an ML model 124A, analyzes the requests stored in the request data store 122 against the policy database 130 to determine how trustworthy or compliant each of the resources has been to the security policies. In some embodiments, this trust analysis is performed based on a preconfigured basis, such for every 10,000 requests stored in the request store database. The trust score engine 124 then generates a trust score for each of the resources. The trust score is an indication of the how trustworthy a resource is at a given point in time. Thus, a resource with higher trust score is more trustworthy than a resource with a lower trust score. As illustrated in FIG. 1, the trust score engine 124 generates a trust score 132 for the resource 102 and a trust score 13 for the resource 104. Although not illustrated, the trust score engine 124 also generates a trust score for the additional resources 106.

In some embodiments, a resource may be considered to comprise various tenants who access or use the resource. For example, the various tenants can include the users of the resource, the devices using the resource, the network that the resource is part of, and the applications that are using the resource. In such embodiments, the various tenants can each have a trust score generated by the trust score engine 124 and the trust score of the resource can be an overall trust score that is based on the trust scores of the tenant.

As illustrated in FIG. 1, the resource 102 comprises a user 136 tenant that has a trust score 138, a device 140 tenant that has a trust score 142, a network 144 tenant that has a trust score 146, and an application 148 tenant that has a trust score 150. As mentioned, the trust score 132 is an overall trust score for the resource 102 and is based on, for example is an average of, the trust scores 138, 142, 146, and 150.

In some embodiments, the requests 110, 112, and/or 114 may be or may be affected by an anomalous event that occurs internally at one of the resources 102, 104, or 106 or that happens externally at one or more or the outside systems 108. In particular, requests that originate from events that can cause resource disruption can have an adverse effect on the trust scores of the various resources. For example, an anomalous event that caused a power loss to the resource 102 could cause the resource to reject all access requests because the resource is not running. In such case, the trust score 132 could be lowered as access policies were not being complied with. However, such non-compliance with the access policies is not withing the normal operation of the resource 102, but is caused by power outage. Thus, it is important for the trust scoring module 118 to take such anomalous events into account when generating the trust score as they can be instructive on the cause of the trust score change and the need to update security policies that take such anomalous events into account.

In addition, it is important to take into account historical trust score patterns. Such patterns can also be instructive on the cause of a trust score change and the need to update security policies. Advantageously, the embodiments disclosed herein provide for mechanisms that account for anomalous events and historical test score patterns when generating or updating the trust scores.

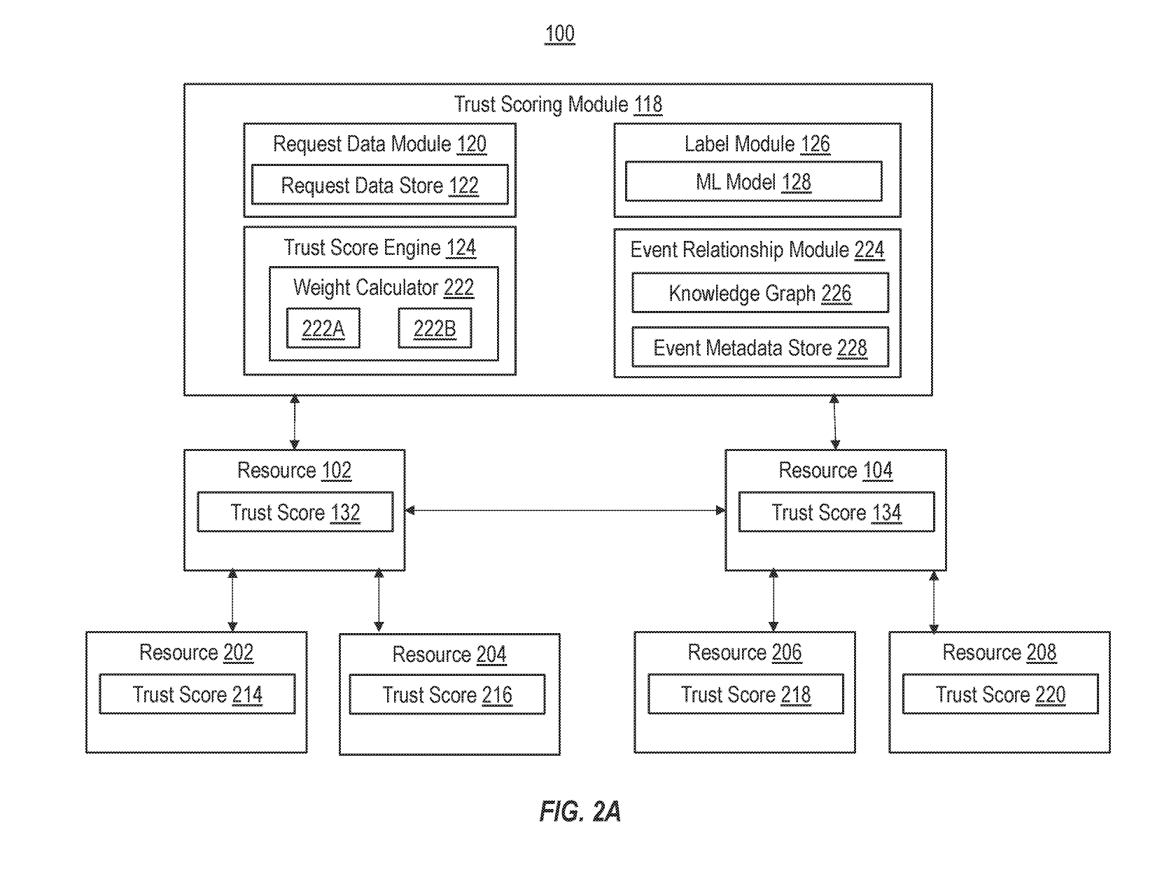

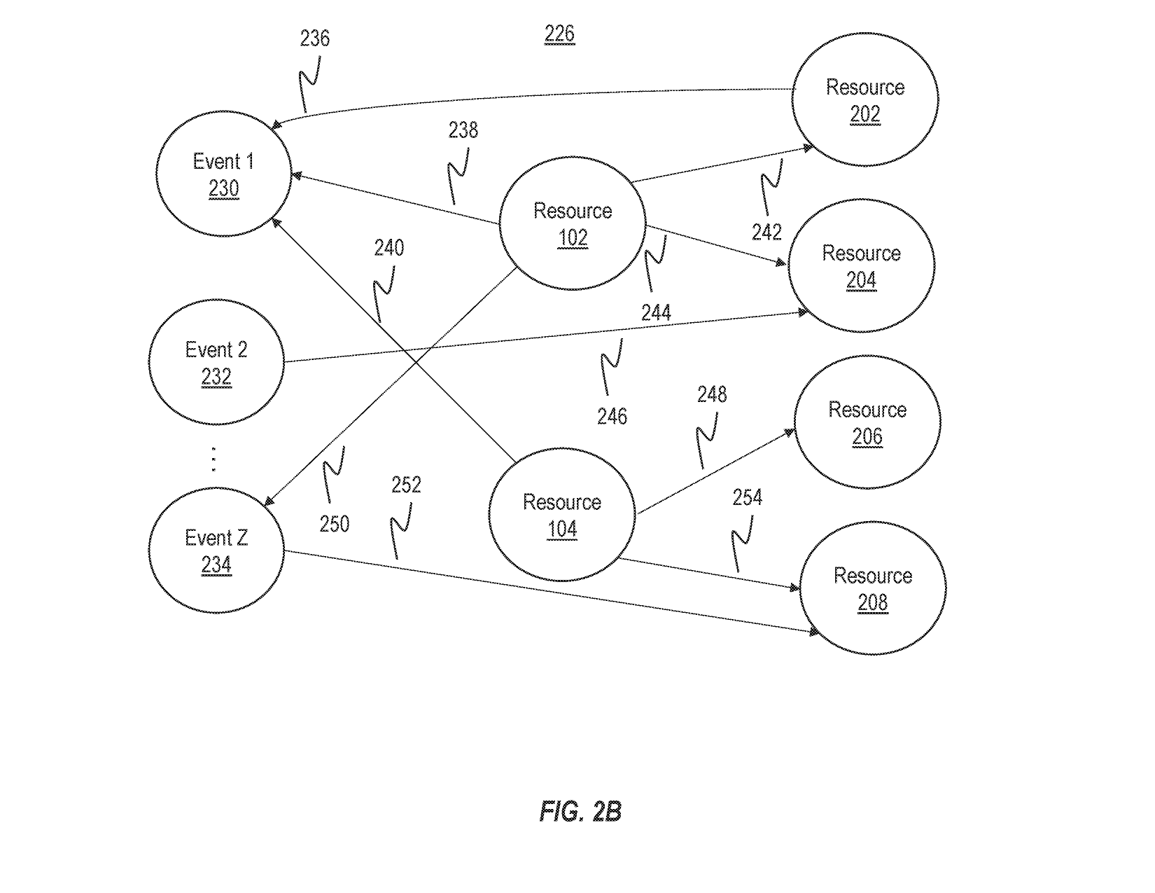

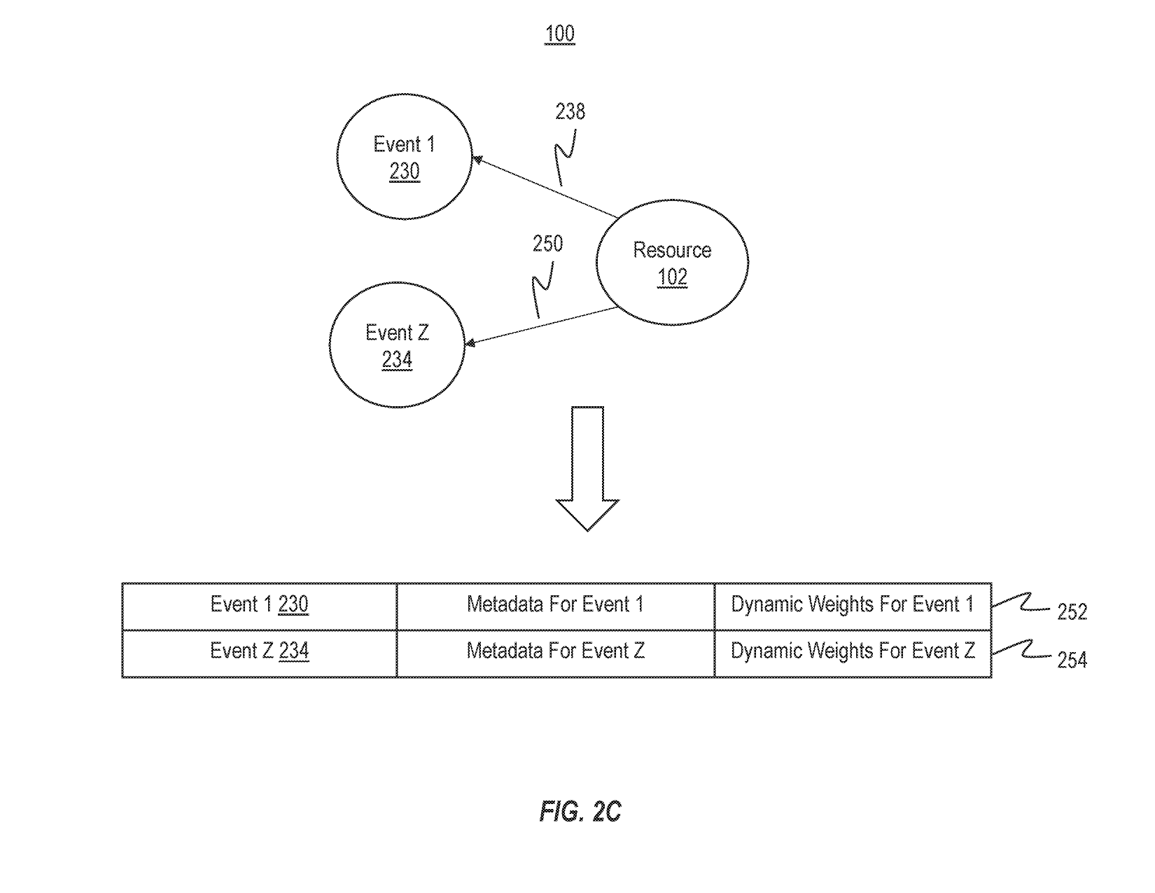

FIGS. 2A-2C illustrate an embodiment of the trust environment 100. As illustrated, the embodiment of FIGS. 2A-2C include some of the same elements as previously discussed in relation to FIG. 1. Accordingly, such elements need not be explained in relation to FIGS. 2A-2C. In addition, those elements shown in FIG. 1, but not shown in FIGS. 2A-2C, can be considered included in FIGS. 2A-2C.

As illustrated, in the embodiment of FIG. 2A the resource 102 is a server that is connected to a resource 202 and a resource 204. For example, the resource 102 can include a hypervisor and the resources 202 and 204 can be virtual machines hosted by the server. Likewise, the resource 104 is also a server that is connected to a resource 206 and a resource 208. For example, the resource 104 can include a microvisor and the resources 206 and 208 can be logically composed systems hosted by the server.

In operation, one or more of the resources 102, 104, 202, 204, 206, and 208 may be subjected to an internal anomalous event. Alternatively , they may receive a request from one or more outside systems 108 that have been subjected to an anomalous event. An anomalous event can include any event that is not expected to occur. In addition, an anomalous event can include any event that does not occur very often, such as a hardware or software update. Examples of anomalous events include, but are not limited to, configuration events causing resource state changes, hardware, software, and firmware updates, changes in resource usage patterns, such as changes from high usage to medium or low usage, events affecting resource availability, such as going from online to offline, and events affecting resource status, such as having the status change from in-use to idle or pending.

As will be appreciated, configuration events causing resource state changes, and hardware, software, and firmware updates can cause a resource to no longer comply with the access and/or operational policies as changes have been made to resource or to the entity trying to access the resource. Changes to resource usage patterns, events affecting resource availability, and events affecting resource status are indicative that an event such as a power loss has occurred that is affecting the resource or to the entity trying to access the resource.

As illustrated, the trust scoring module 118 includes an event relationship module 224. In operation, the event relationship module 224 determines relationships between one or more of the event labeled by the label module 126 and the resources 102, 104, 202, 204, 206, and 208. In other words, event relationship module 224 determines the effect an event has one resource and by inference on any resources that are related to the one resource. In one embodiment, the event relationship module 224 generates a knowledge graph 226 while determining the relationship between the events and the resources.

FIG. 2B illustrates an embodiment of the knowledge graph 226. As illustrated, the figure shows event types as classifiers and the resources as entities for which these events could be related to. If an event has occurred for a resource, an edge exists between the event node to the resource node. For example, an edge 238 exists between the event 1 230 and resource 102 and an edge 250 exists between an event Z 234 and resource 102, showing that event 1 230 and event Z 234 occurred for resource 102. Since resource 102 is a server that is hosting resource 202 and resource 204, it can be inferred that event 1 230 and/or event Z 234 also occurred for the resources 202 and 204. This inference is shown by edges 242 and 244. For resource 202, an edge 236 exits between the resource 202 and the event 1 230, showing that event 1 230 occurred for the resource 202 independent of the inference shown by edge 242. For resource 204, an edge 246 exits between the resource 204 and an event 2 232, showing that event 2 232 occurred for the resource 204 even though event 2 232 did not occur for the resource 102.

Likewise, an edge 240 exists between the event 1 230 and resource 104, showing that event 1 230 occurred for resource 104. Since resource 104 is a server that is hosting resource 206 and resource 208, it can be inferred that event 1 230 also occurred for the resources 206 and 208. This inference is shown by edges 248 and 254. For resource 208, an edge 252 exits between the resource 208 and the event Z 234, showing that event Z 234 occurred for the resource 208 even though event Z 234 did not occur for the resource 104.

As illustrated in FIG. 2A, the event relationship module 224 includes an event metadata store 228. In operation, the event relationship module 224 records event metadata about the anomalous events previously described. In other words, the event relationship module 224 records event metadata from the edges between the event and a resource. In some embodiments, the event metadata includes, but is not limited to, event count, initial occurrence of the event, average rate of occurrence of the event, average trust score deviation caused by the event, average outage period caused by the event, number of correlated resources affected by the event, or dependent consumers affected by the event. Of particular importance is event metadata that specifies an "historical rate of occurrence" of an event and the "severity of impact" of the event.

The event metadata is then used to either update or generate trust scores for each of the resources. For example, the trust score engine 124 includes a weight calculator 222, which may be part of the ML model 124A, that calculates a dynamic weight, such as a dynamic weight 222A and 222B, for each of the event metadata occurring for each resource. The dynamic weights 222A and 222B are then used by the trust score engine 124 for updating or generating trust scores.

In one embodiment, configured or default base weight factors for the event metadata values are used, for example defaults of high (0.5), medium(0.35), low(0.15) can factored for each of the field values. Higher event transaction frequency to a given resource potentially increases probability of disruption to this resource. In such case, dynamic policy updates are required for this resource to maintain acceptable degrees of trustworthiness within the trust environment 100.

For example, suppose the resource 102 is a compute resource running a workload and that a firmware update event occurs for the resource. In such case, the firmware update event would have a metadata count value equal to 1 among other event metadata. The dynamic weight contribution will be low (0.15) for occurrence because it has only happened once, but will be high (0.5) for severity, because the firmware update can cause some downtime and workload disruption. The other event metadata would also have dynamic weights determined for them based on the "historical rate of occurrence" of an event and the "severity of impact" of the event.

FIG. 2C illustrates the process of determining event metadata and then using the event metadata to determine dynamic weights for the resource 102. FIG. 2C shows the portion of the knowledge graph 226 showing the event 1 230 and event Z 234 that occur for the resource 102 and the edges 238 and 250 between the events and the resource as previously described. As shown at 252, the event metadata for event 1 230 is used to generate dynamic weights for event 1 230 for resource 102. Likewise, as shown at 254, the event metadata for event Z 234 is used to generate dynamic weights for event Z 234 for resource 104.

In one embodiment, the trust score engine 124 uses the following to generate or update a trust score: Resource trust score (TS) = Weighted TS – Weighted Sum (Event(s) impact). Thus, in the embodiment of FIG. 2A, the trust scores 132, 134, 214, 216, 218, and 220 for the resources 102, 104, 202, 20, 206, and 208 respectively are either updated or generated using the dynamic weights 222A and 222B.

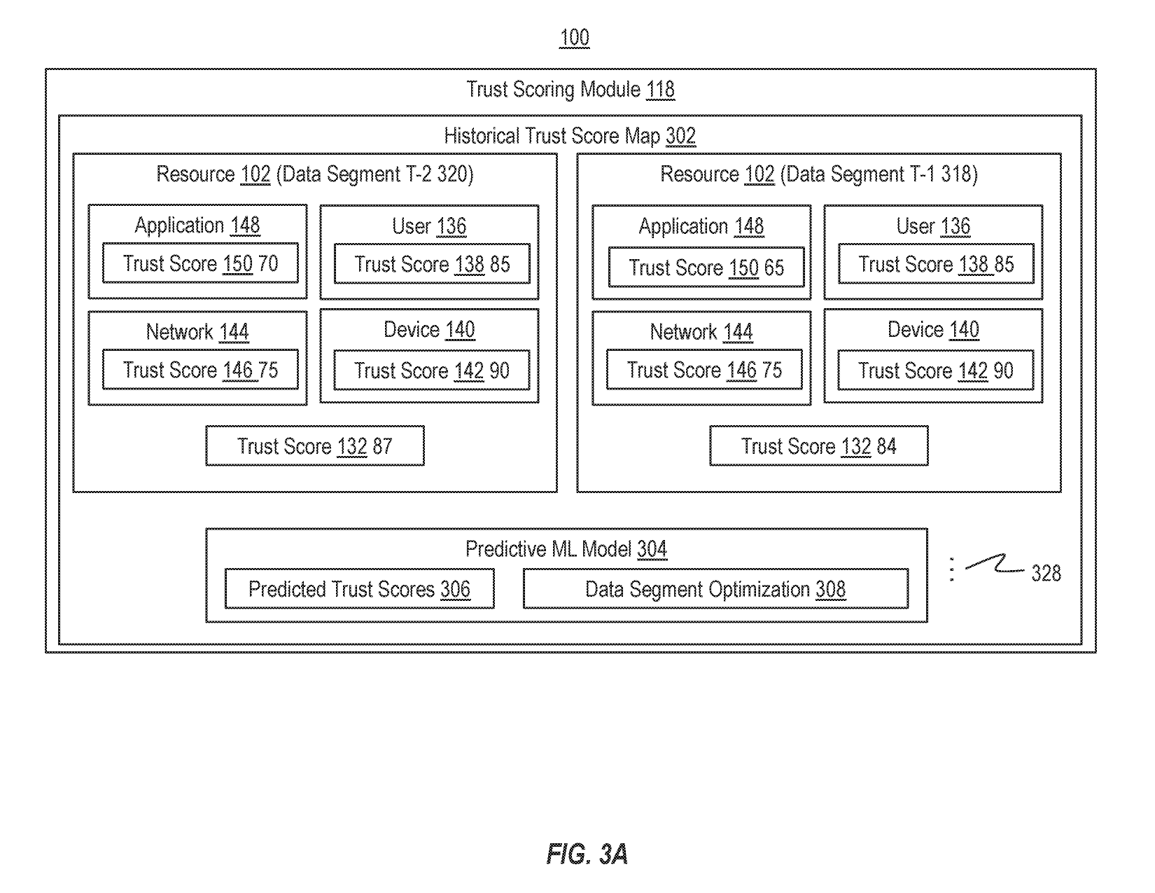

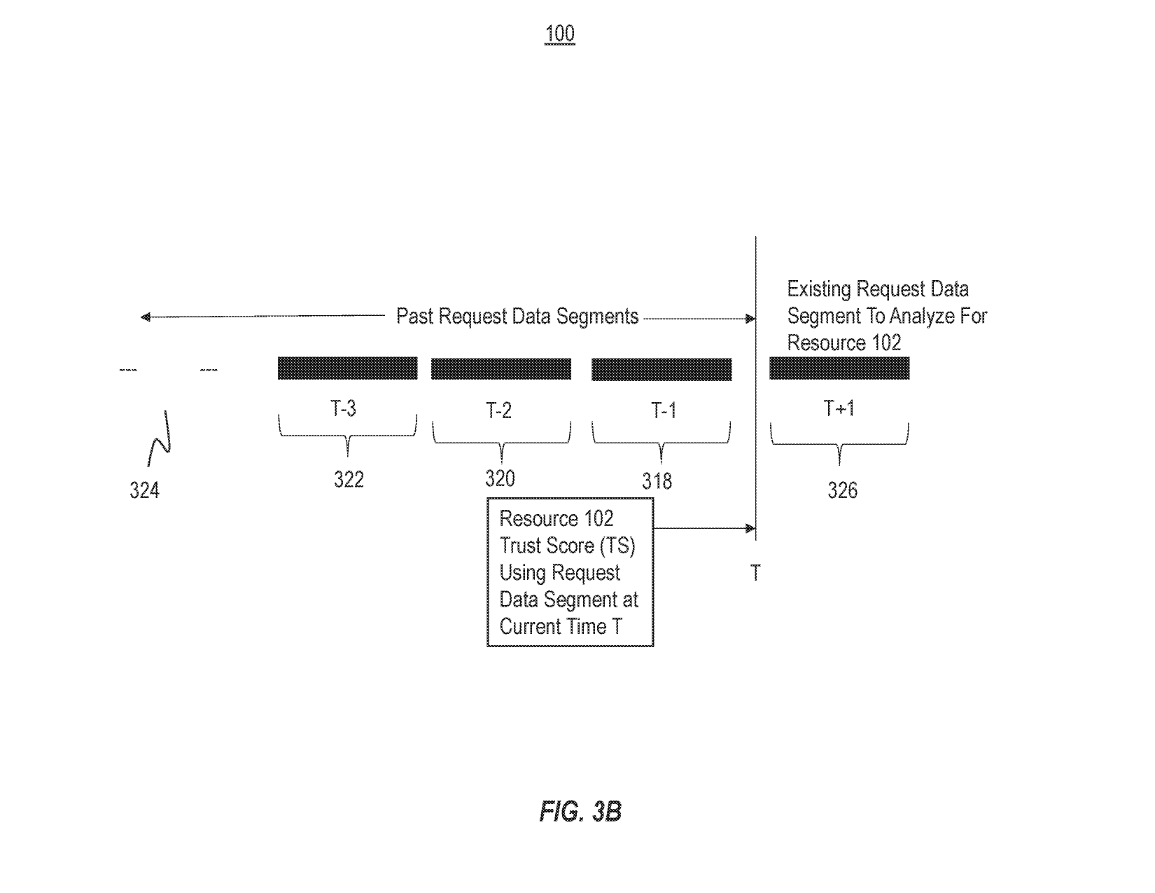

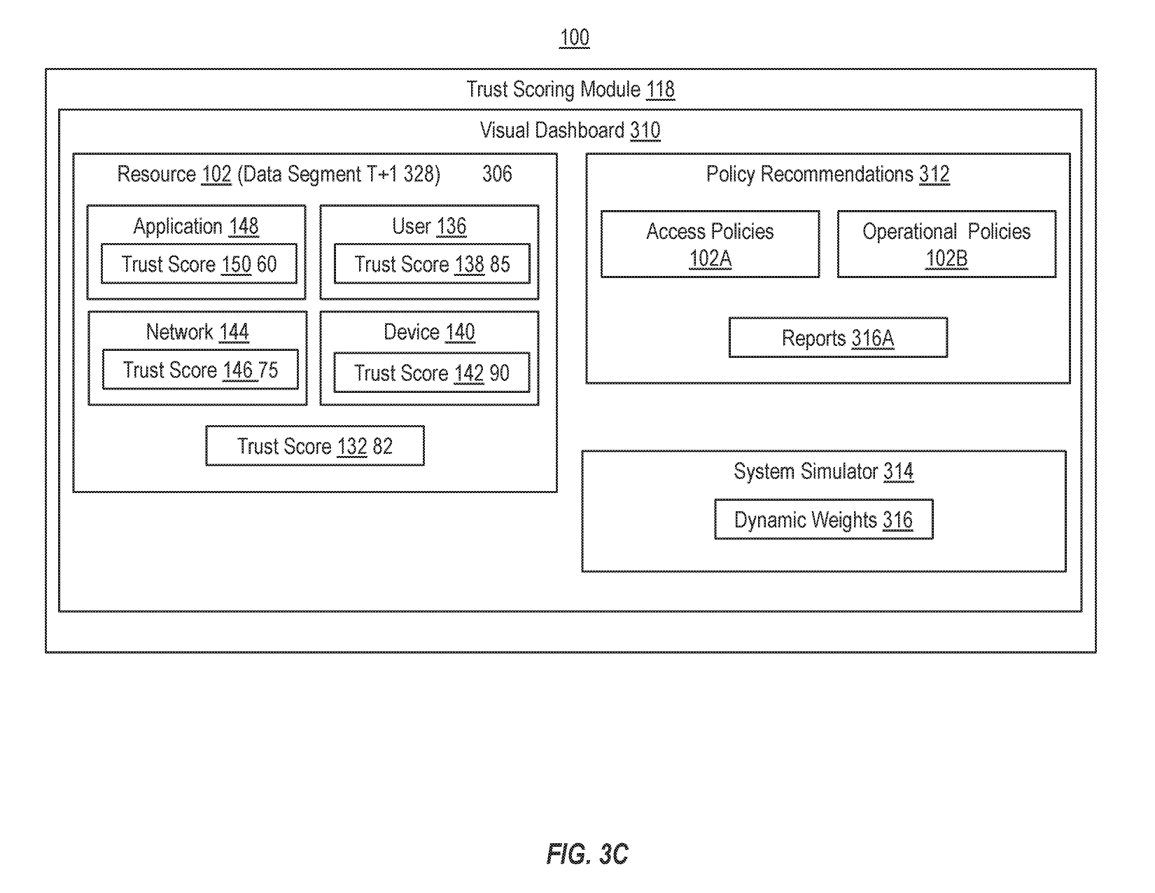

FIGS. 3A-3C illustrate an embodiment of the trust environment 100. As illustrated, the embodiment of FIGS. 3A-3C include some of the same elements as previously discussed in relation to FIGS. 1 and 2A-2C. Accordingly, such elements need not be explained in relation to FIGS. 3A-3C. In addition, those elements shown in FIGS. 1 and 2A-2C, but not shown in FIGS. 3A-3C, can be considered included in FIGS. 3A-3C.

As illustrated in FIG. 3A, the trust scoring module 118 includes a historical trust score map 302. In operation, the historical trust score map 302 stores past trust scores for each of the resources and their tenants of the trust environment 100. In particular, the historical trust score map 302 stores past trust scores for the resources that were generated using a predetermined request data segment of requests that are stored in the request data store 122. For example, the predetermined data segment may include 10,000 requests. For example, as shown in FIG. 3B the historical trust score map 302 stores past trust scores for the resource 102 collected during a request data segment T-1 318, a request data segment T-2 320, a request data segment T-3 322, and additional past request data segments 324 illustrated by the ellipses.

As will be appreciated, some resources receive a relatively continuous stream of requests while other resources receive requests at a much slower rate. The historical trust score map 302 would need to be updated more frequently for the resources receiving the relatively continuous stream of requests than for the resources that receive less requests. Thus, the historical trust score map 302 for the resources receiving the relatively continuous stream of requests might be updated several times a day while the historical trust score map 302 might only be updated once every few days for the resources that receive less requests. By dictating updates to the historical trust score map 302 on the predetermined request data segment of requests that are stored in the request data store 122 rather than a predetermined time period, computing resources are saved as updates to the historical trust score map are only done when enough new requests are stored for a given resource.

FIG. 3A illustrates an embodiment of the historical trust score map 302 storing past trust scores for resource 102 generated using the request data segments T-1 318 and T-2 320. Although not illustrated, past trust scores for resource 102 generated using the request data segments 322 and 324 could also be stored in the historical trust score map 302. In addition, although not illustrated, the past trust scores for the resources 104 and 106 and their tenants if applicable can also be stored in the historical trust score map 302 for the request data segments T-1 318, T-2 320, T-3 322, and additional request data segments 324. The non-illustrated past trust scores are illustrated by the ellipses 328.

As illustrated for the request data segment T-2 320, user 136 tenant has a trust score 138 having a value of 85, device 140 tenant has a trust score 142 having a value of 90, network 144 tenant has a trust score 146 having a value of 75, and application 148 tenant has a trust score 150 having a value of 70. This leads to an overall trust score of 87.

At request data segment T-1 318, which is the data segment used before the current data segment at the current time T is used, user 136 tenant has a trust score 138 having a value of 85, device 140 tenant has a trust score 142 having a value of 90, network 144 tenant has a trust score 146 having a value of 75, and application 148 tenant has a trust score 150 having a value of 65. This leads to an overall trust score of 84. It is noted that the trust score 150 for application 148 changed from request segment T-2 320 to request data segment T-1 318, thus causing the overall trust score for the resource 102 to also change.

The test scoring module 118 includes or otherwise has access to a predictive ML model 304. In operation, predictive ML model 304 is trained using the past trust scores for all the resource and their tenants that are stored in the historical trust score map 302. Once trained, predictive ML model 304 is able to use the past trust scores for all the resource and their tenants that are stored in the historical trust score map 302 to determine predicted trust scores 306 generated using future predicted request data segments. For example, as shown in FIG. 3B predictive ML model 304 uses the request data segment at the current time T to predict what the trust scores for resource 102 and its tenants will be when generated using a predicted future data request segment T+1 326.

The test scoring module 118 includes or otherwise has access to a visual dashboard 310 as illustrated in FIG. 3C. In operation, the visual dashboard 310 has user interface elements that provide information to a user about the trust scores and ways to help optimize the trust scores. For example, the visual dashboard 310 can display the predicated trust scores 306 from predictive ML model 304. As illustrated in FIG. 3C, the predicated trust scores 306 using the predicted future data request segment T+1 326 includes user 136 tenant having a trust score 138 having a value of 85, device 140 tenant having a trust score 142 having a value of 90, network 144 tenant having a trust score 146 having a value of 75, and application 148 tenant having a trust score 150 having a value of 60. This leads to an overall trust score of 82. It is noted that the trust score 150 for application 148 has been predicated to continue to drift lower. This drifting leads to the lowering of the overall trust score. Thus, it can be inferred by the user that there is a request problem for the application 148 tenant that is causing it trust score to drift lower, thus lowering the overall trust score of resource 102. The user is then able to investigate the application 148 tenant to determine the cause of the trust score drift. The causes can include anomalous access request patterns or a failure in the operation of the resource.

In some embodiments, predictive ML model 304 is able to suggest policy update, modifications, and/or recommendations 312 for improving the overall trust score of a resource based on the predictions the model has made. For example, predictive ML model 304 is able to suggest policy modifications that can prevent the trust score drift of application 148 previously described. The policy updates, modifications, and/or recommendations 312 can be shown to the user as part of the visual dashboard 310. For example, in the illustrated embodiment the visual dashboard shows policy updates, modifications, and/or recommendations 312 for the access policies 102A and operational policies 102B that can prevent the trust score drift of application 148 previously described. The visual dashboard 310 can also show various reports 316A that provide further information to the user about anomalous access request patterns or a failure in the operation of the resource.

Predictive ML model 304 is also able to perform data segment optimization 308. While performing the data segment optimization 308, predictive ML model 304 uses the past trust scores for all the resource and their tenants that are stored in the historical trust score map 302 to optimize the request data segments for a specific environment and/or resource that are used in the present trust scores at the current time T. This optimization can include using adaptive analysis thresholding to determine an optimal number of request samples to include in a request data segment or determining the types of request to use. The adaptive analysis thresholding can also help to determine anomalous access patterns in the received requests. This information can then be used by the trust score engine 124 for making a more precise calculation of the present trust scores at the current time T.

In some embodiments, the trust scoring module 318 includes a system simulator 314 that can be shown in the visual dashboard 310. In operation, the system simulator 314 allows a user to vary the dynamic weights 222A and 222B previously discussed. In particular, a user can specify that varied dynamic weights 316 that are based on different potential anomalous events be used by the trust score engine 124 to simulate how a resource adapts to different anomalous events that can affect the trust scores. This allows the user to proactively determine corrections to such potential anomalous events.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

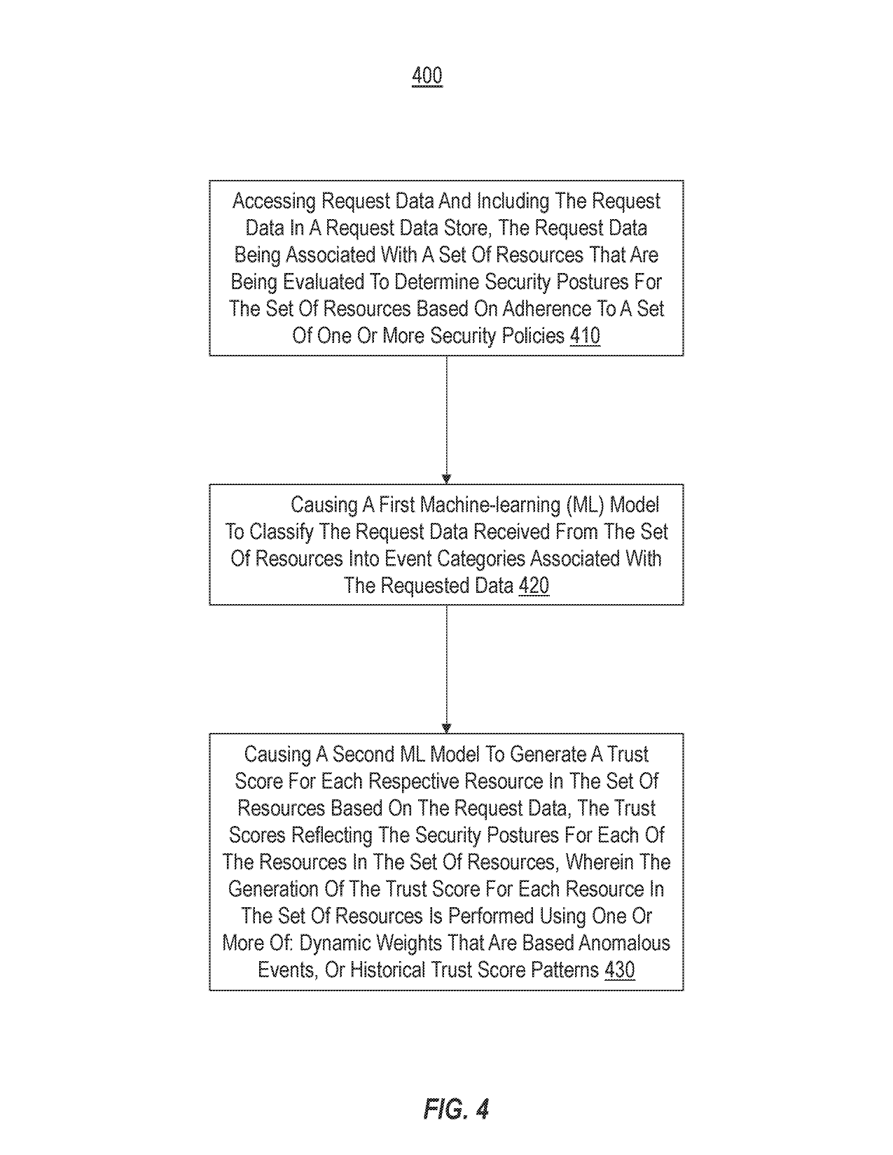

Directing attention now to FIG. 4, an example method 400 is disclosed. The method 400 will be described in relation to one or more of the figures previously described, although the method 400 is not limited to any particular embodiment.

The method 400 includes accessing request data and including the request data in a request data store, the request data being associated with a set of resources that are being evaluated to determine security postures for the set of resources based on adherence to a set of one or more security policies (410). For example, the data from the requests 110, 112, and 114 is stored in the request data store 122 for each of the resources 102, 104, and 106 and their tenants if applicable. The request data is used to determine the security postures of the resources in the manner previously explained.

The method 400 includes causing a first machine-learning (ML) model to classify the request data received from the set of resources into event categories associated with the requested data (420). For example, as previously described label module 126 uses the ML model 128 to label the request data in the request data as different event categories.

The method 400 includes causing a second ML model to generate a trust score for each respective resource in the set of resources based on the request data, the trust scores reflecting the security postures for each of the resources in the set of resources, wherein the generation of the trust score for each resource in the set of resources is performed using one or more of dynamic weights that are based anomalous events, or historical trust score patterns (430). For example, as previously described the trust score engine 124 generates a trust score for each of the resources 102, 104, and 106 and their tenants. The generation of the trust scores includes calculating and using the dynamic weights 222A and 222B in the manner previously described in relation to FIGS. 2A-2C or using historical trust score patterns described in relation to FIGS. 3A-3C.

### Further Example Embodiments

Following are some further example embodiments of the invention. These are presented only by way of example and are not intended to limit the scope of the invention in any way.

Embodiment 1. A method, comprising: accessing request data and including the request data in a request data store, the request data being associated with a set of resources that are being evaluated to determine security postures for the set of resources based on adherence to a set of one or more security policies; causing a first machine-learning (ML) model to classify the request data received from the set of resources into event categories associated with the requested data; causing a second ML model to generate a trust score for each respective resource in the set of resources based on the request data, the trust scores reflecting the security postures for each of the resources in the set of resources, wherein the generation of the trust score for each resource in the set of resources is performed using one or more of: dynamic weights that are based on anomalous events, or historical trust score patterns.

Embodiment 2. The method of Embodiment 1, wherein trust scores are also generated for one or more tenants of the resources of the set of resources using one or more of: the dynamic weights that are based on anomalous events, or the historical trust score patterns.

Embodiment 3. The method of Embodiment 1, wherein performing the generation of the trust scores using the dynamic weights that are based anomalous events comprises: calculating the dynamic weights, wherein the dynamic weights specify how the anomalous events affect the resources of the set of resources; using the calculated dynamic weights in the generation of the trust scores.

Embodiment 4. The method of Embodiment 3, wherein calculating the dynamic weights comprises: determining a relationship between the respective resources of the set of resources; and determining when an anomalous event that affects a first resource of the set of resources also affects a second resource of the set of resources that is related to the first resource of the set of resources.

Embodiment 5. The method of Embodiment 4, wherein determining a relationship between the respective resources of the set of resources comprises generating a knowledge graph, the knowledge graph including first nodes represent the anomalous events, second nodes representing resources of the set of resources, and edges that link the first and second nodes, the edges showing the relationship between the resources and the anomalous events affecting the resources.

Embodiment 6. The method of Embodiment 3, wherein calculating the dynamic weights comprises: collecting metadata about the anomalous events, the metadata specifying a rate of occurrence of the anomalous events and a severity of impact of the anomalous events on an operation of the resources of the set of resources.

Embodiment 7. The method of Embodiment 1, wherein the anomalous events include one or more of configuration events causing resource state changes, hardware, software, and firmware updates, changes in resource usage patterns, events affecting resource availability, and events affecting resource status.

Embodiment 8. The method of Embodiment 1, wherein performing the generation of the trust scores using historical trust score patterns comprises: using a third ML model to determine data segments comprising portions of the request data that should be used in generating the trust scores; and using the data segments to determine past trust scores for each resource of the set of resources that are to be stored in a historical trust score map.

Embodiment 9. The method of Embodiment 8, further comprising: causing the third ML model to use the past trust scores stored in the historical trust score map to predict future trust scores for each of the resources in the set of resources.

Embodiment 10. The method of Embodiment 9, further comprising: causing the third ML model to use the predicted future trust scores to determine trust score drift and to recommend modifications to the security policies to correct the trust score drift.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

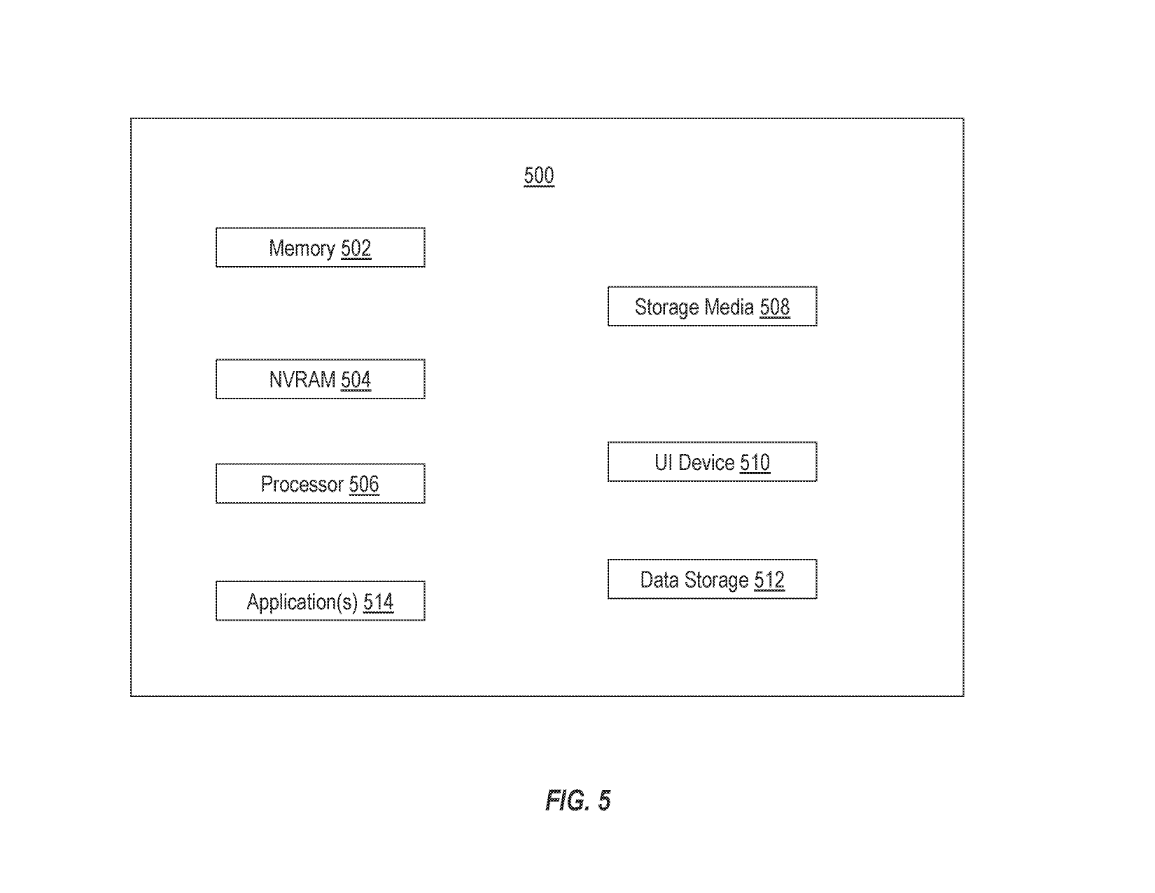

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more components of the memory 502 of the physical computing device 504 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The described embodiments are to be considered in all respects only as illustrative and not restrictive. All changes which come within the meaning and range of equivalency of the claims are to be embraced within their scope.

What is claimed is:

1. A method, comprising:
accessing request data and including the request data in a request data store, the request data being associated with a set of resources that are being evaluated to determine security postures for the set of resources based on adherence to a set of one or more security policies;
causing a first machine-learning (ML) model to classify the request data received from the set of resources into event categories associated with the requested data;
causing a second ML model to generate a trust score for each respective resource in the set of resources based on the request data, the trust scores reflecting the security postures for each of the resources in the set of resources, wherein the generation of the trust score for each resource in the set of resources is performed using one or more of:
dynamic weights that are based on anomalous events, or
historical trust score patterns.

2. The method of claim 1, wherein trust scores are also generated for one or more tenants of the resources of the set of resources using one or more of:
the dynamic weights that are based on anomalous events, or
the historical trust score patterns.

3. The method of claim 1, wherein performing the generation of the trust scores using the dynamic weights that are based on anomalous events comprises:
calculating the dynamic weights, wherein the dynamic weights specify how the anomalous events affect the resources of the set of resources;
using the calculated dynamic weights in the generation of the trust scores.

4. The method of claim 3, wherein calculating the dynamic weights comprises:
determining a relationship between the respective resources of the set of resources; and
determining when an anomalous event that affects a first resource of the set of resources also affects a second resource of the set of resources that is related to the first resource of the set of resources.

5. The method of claim 4, wherein determining a relationship between the respective resources of the set of resources comprises generating a knowledge graph, the knowledge graph including first nodes represent the anomalous events, second nodes representing resources of the set of resources, and edges that link the first and second nodes, the edges showing the relationship between the resources and the anomalous events affecting the resources.

6. The method of claim 3, wherein calculating the dynamic weights comprises:
collecting metadata about the anomalous events, the metadata specifying a rate of occurrence of the anomalous events and a severity of impact of the anomalous events on an operation of the resources of the set of resources.

7. The method of claim 1, wherein the anomalous events include one or more of configuration events causing resource state changes, hardware, software, and firmware updates, changes in resource usage patterns, events affecting resource availability, and events affecting resource status.

8. The method of claim 1, wherein performing the generation of the trust scores using historical trust score patterns comprises:
using a third ML model to determine data segments comprising portions of the request data that should be used in generating the trust scores; and
using the data segments to determine past trust scores for each resource of the set of resources that are to be stored in a historical trust score map.

9. The method of claim 8, further comprising:
causing the third ML model to use the past trust scores stored in the historical trust score map to predict future trust scores for each of the resources in the set of resources.

10. The method of claim 9, further comprising:
causing the third ML model to use the predicted future trust scores to determine trust score drift and to recommend modifications to the security policies to correct the trust score drift.

11. A non-transitory storage medium having stored therein instructions that are executable by one or more hardware processors to perform operations comprising:
accessing request data and including the request data in a request data store, the request data being associated with a set of resources that are being evaluated to determine security postures for the set of resources based on adherence to a set of one or more security policies;
causing a first machine-learning (ML) model to classify the request data received from the set of resources into event categories associated with the requested data;
causing a second ML model to generate a trust score for each respective resource in the set of resources based on the request data, the trust scores reflecting the security postures for each of the resources in the set of resources, wherein the generation of the trust score for each resource in the set of resources is performed using one or more of:
dynamic weights that are based on anomalous events, or
historical trust score patterns.

12. The non-transitory storage medium of claim 11, wherein trust scores are also generated for one or more tenants of the resources of the set of resources using one or more of:
the dynamic weights that are based on anomalous events, or
the historical trust score patterns.

13. The non-transitory storage medium of claim 11, wherein performing the generation of the trust scores using the dynamic weights that are based on anomalous events comprises:
calculating the dynamic weights, wherein the dynamic weights specify how the anomalous events affect the resources of the set of resources;
using the calculated dynamic weights in the generation of the trust scores.

14. The non-transitory storage medium of claim 13, wherein calculating the dynamic weights comprises:
determining a relationship between the respective resources of the set of resources; and
determining when an anomalous event that affects a first resource of the set of resources also affects a second resource of the set of resources that is related to the first resource of the set of resources.

15. The non-transitory storage medium of claim 14, wherein determining a relationship between the respective resources of the set of resources comprises generating a knowledge graph, the knowledge graph including first nodes represent the anomalous events, second nodes representing resources of the set of resources, and edges that link the first and second nodes, the edges showing the relationship between the resources and the anomalous events affecting the resources.

16. The non-transitory storage medium of claim 13, wherein calculating the dynamic weights comprises:
collecting metadata about the anomalous events, the metadata specifying a rate of occurrence of the anomalous events and a severity of impact of the anomalous events on an operation of the resources of the set of resources.

17. The non-transitory storage medium of claim 11, wherein the anomalous events include one or more of configuration events causing resource state changes, hardware, software, and firmware updates, changes in resource usage patterns, events affecting resource availability, and events affecting resource status.

18. The non-transitory storage medium of claim 17, wherein performing the generation of the trust scores using historical trust score patterns comprises:
using a third ML model to determine data segments comprising portions of the request data that should be used in generating the trust scores; and
using the data segments to determine past trust scores for each resource of the set of resources that are to be stored in a historical trust score map.

19. The non-transitory storage medium of claim 18, further comprising:
causing the third ML model to use the past trust scores stored in the historical trust score map to predict future trust scores for each of the resources in the set of resources.

20. The non-transitory storage medium of claim 19, further comprising:
causing the third ML model to use the predicted future trust scores to determine trust score drift and to recommend modifications to the security policies to correct the trust score drift.
